(19) United States
(12) Patent Application Publication
(10) Pub. No.: US 2007/0277127 A1
(43) Pub. Date: Nov. 29, 2007

(54) SCREENSAVER FOR INDIVIDUAL APPLICATION PROGRAMS

(76) Inventors: Michael P. Carlson, Austin, TX (US); Herman Rodriguez, Austin, TX (US)

Correspondence Address: STREETS & STEELE, 13831 NORTHWEST FREEWAY, SUITE 355, HOUSTON, TX, 77040, US

(21) Appl. No.: 11/420,087

(22) Filed: May 24, 2006

(51) Int. Cl. G06F 17/00

(52) U.S. Cl. 715/867

(57) ABSTRACT

Methods, computer program products and systems for operating an application screensaver on a computer system. A screensaver activation condition is stored for one or more application programs on the computer. The screensaver is activated to overlay the client area of a running application window in response to detecting a screensaver activation condition for that application program. A screensaver process or image may be deactivated in response to no longer detecting the occurrence of the stored screensaver activation condition for that application. A screensaver activation condition may be a period of inactivity with the application program. A global desktop screensaver property may also be stored and include global desktop screensaver activation and deactivation conditions, which are used to activate and deactivate a global desktop screensaver process that overlays application program windows. Optionally, application program screensavers may be deactivated in response to deactivation of the global desktop screensaver.

### BACKGROUND OF THE INVENTION

1. Field of the Invention

This invention relates generally to improved screensaver methods and systems.

2. Description of the Related Art

A screensaver program is a computer program that monitors user interactivity with a computer and changes the screen display in response to detecting a certain period of inactivity. The usefulness of the very first screensaver programs was primarily directed toward preventing an image from burning into the screen. Of primary concern were menu bars or other graphical elements of programs that remained in the same place for extended periods of time, resulting in a permanent shadow on the screen.

However, current computer display technology does not suffer from these problems and screensaver have been subsequently used primarily to maintain the privacy and security of information that may be displayed on a desktop computer. Existing screensaver programs monitor user inactivity with a computer and display a full screen image in response to a sufficient period of inactivity. The screensaver is typically deactivated when the user resumes activity on the computer, such as by moving a mouse or typing on a keyboard.

These and similar screensavers do not provide much security over the information on a computer display. For example, a program with proprietary information can be viewed by anyone walking up to the computer so long as the screensaver has not yet been activated. Furthermore, by continuing some form of activity on the computer, there is generally no limit on access to programs that are already open and running on the computer.

One popular communications software application, Lotus Notes (a trademark of Lotus Development Corporation), includes an autologoff feature to prevent inadvertent disclosure of private information. While this implementation prevents unauthorized disclosure after a predetermined inactivity time, it presents a usability problem in that the user must login to Notes and re-establish a Notes session. Furthermore, this feature is built into the Lotus Notes application itself and is not a general purpose solution that can be applied across multiple applications.

Accordingly, there is a continuing need for improved security systems and methods for protecting information on a computer from being accessed or viewed without authority. There is also a need for security systems and methods that are easily customized to balance the benefits of high security, where needed, with the convenience of broad access.

### SUMMARY OF THE INVENTION

Embodiments of the present invention include methods, computer program products and systems for operating a screensaver on a computer system having a display screen. The method includes the steps of storing a screensaver activation condition for at least one application program selected from a plurality of application programs stored on the computer system, and activating a screensaver process to overlay the client area of at least one running application window associated with the selected at least one application program in response to detecting the occurrence of the stored screensaver activation condition. Optionally, the activated screensaver process overlays the client area of the at least one running application window and does not overlay the client area of any other running application window.

The method of a particular embodiment may further include the step of deactivating the screensaver process to expose the client area of the at least one running application window in response to no longer detecting the occurrence of the stored screensaver activation condition. Furthermore, the storing of a screensaver activation condition may further comprise installing a screensaver at the time the at least one application program is installed, identifying the screensaver activation condition at the time the at least one application program is installed, and storing the identified screensaver activation condition in a properties file associated with the application program, such as an INI file associated with the at least one application program.

Further steps of a particular embodiment may include the step of storing the identification of a screensaver process for the at least one application program in an INI file associated with a plurality of screensavers. The screensaver activation condition for the application program may comprise a period of inactivity of the at least one application program. Still further, the method may include disabling access to the client area of at least one running application window in response to detecting the occurrence of the stored screensaver activation condition, and enabling access to the client area of at least one running application window in response to no longer detecting the occurrence of the stored screensaver activation condition.

In another embodiment, the method may further comprise storing a global desktop screensaver activation condition for the desktop of the computer system, and activating a global desktop screensaver process to overlay the client area of each running application window in response to detecting occurrence of the stored screensaver activation condition for the global desktop screensaver. The global desktop screensaver process may be deactivated to expose the client area of each running application window in response to no longer detecting the occurrence of the stored screensaver activation condition for the global desktop screensaver. Optionally, the method may further comprise deactivating the at least one application program screensaver process in response to no longer detecting the occurrence of the screensaver activation condition for the global desktop screensaver. Still further, the method may include, for example, disabling access to the client area of each running application window in response to detecting the occurrence of the stored screensaver activation condition for the global desktop screensaver, and enabling access to the client area of at least one running application window in response to no longer detecting the occurrence of the stored screensaver activation condition for the global desktop screensaver. Yet further, the screensaver activation condition for the global desktop screensaver may comprise a period of inactivity greater than or equal to the period of inactivity of the at least one application program. Optionally, the screensaver activation condition for the global desktop screensaver is responsive to activating all screensaver processes of the at least one running application window.

In one embodiment, the method includes detecting that the at least one running application window is being resized, and resizing the overlaid client area of the at least one running application window in response to detecting that the at least one running application window is being resized. In a further embodiment, the period of inactivity is user defined for a plurality of application programs. In a still further embodiment, the method includes identifying a master screensaver deactivation condition, and using the identified master screensaver deactivation condition to expose the client area of each running application window.

Another embodiment of the present invention includes a computer program product comprising a computer useable medium having computer usable code for operating a screensaver on a computer system, the computer product comprising computer useable program code for storing a screensaver activation condition for the at least one application program selected from a plurality of application programs stored on the computer system, and computer useable program code for activating a screensaver process to overlay only the client area of at least one running application window associated with the selected at least one application program in response to detecting the occurrence of the stored screensaver activation condition. The computer program product may further comprise computer useable program code for deactivating the screensaver process to expose the client area of the at least one running application window in response to detecting the occurrence of the stored screensaver activation condition. Still further, the computer program product may further comprise computer useable program code for storing a global desktop screensaver activation condition for the desktop of the computer system, and computer useable program code for activating a global desktop screensaver process to overlay the client area of each running application window in response to detecting the occurrence of the stored screensaver activation condition for the global desktop screensaver. The computer program product may additionally comprise computer useable program code for deactivating the global desktop screensaver process to expose the client area of each running application window in response to no longer detecting the occurrence of the stored screensaver activation condition for the global desktop screensaver.

The present invention further includes a system for operating a screensaver. The system comprises one or more processors coupled directly or indirectly to one or more memory devices and input/output devices, the input device adapted for loading an application program into at least one of the memory devices during installation of the application program on the computer system, wherein the application program includes a logical structure to provide instructions to the one or more processors for storing a screensaver activation condition for at least one application program selected from a plurality of application programs stored on the computer system, and activating a screensaver process to overlay the client area of at least one running application window associated with the selected at least one application program in response to detecting the occurrence of the stored screensaver activation condition. Optionally, the application program may further provide instructions to the one or more processors for deactivating the screensaver process to expose the client area of the at least one running application window in response to no longer detecting the occurrence of the stored screensaver activation condition. In a further option, the application program may further provide instructions to the one or more processors for storing a global desktop screensaver activation condition for the desktop of the computer system, activating a global desktop screensaver process to overlay the client area of each running application windows in response to detecting occurrence of the stored screensaver activation condition for the global desktop screensaver, and deactivating the global desktop screensaver process in response to detecting occurrence of the global desktop screensaver deactivation condition.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a schematic diagram of a system that is suitable for operating a screensaver in accordance with the present invention.

FIGS. 2A-B provide a flow chart of an exemplary method for the setup or editing of screensaver properties for the global desktop and individual applications.

FIGS. 3A-B provide a flow chart of an exemplary method for operating the screensaver in accordance with the screensaver properties.

### DETAILED DESCRIPTION OF PREFERRED EMBODIMENTS

The present invention provides systems, computer program products and methods that are useful for operating a screensaver on a computer system as part of a computer application program installation. While the methods and apparatus that are included in the field of data processing comprise a wide variety of programs and programming languages, those having ordinary skill in the art will appreciate that the present invention may be implemented without limitation to a particular program or programming language, a particular application program or a particular system.

Particular embodiments of the methods, computer program products and systems of the present invention are useful for protecting privacy and maintaining security of information that may be displayed by a running application program on a desktop computer or other type of computing device. In a particular embodiment, a method of the present invention includes storing screensaver properties, such as a screensaver activation condition, for at least one application program selected from a plurality of application programs stored on the computer system. A screensaver process is activated to overlay the client area of at least one running application window for the application program in response to detecting the occurrence of the stored screensaver activation condition specified in the screensaver properties for the application program. The screensaver process is deactivated to expose the client area of the at least one running application window of the application program in response to no longer detecting the occurrence or existence of the stored screensaver activation condition specified in the screensaver properties for the application program. Preferably, the management of any particular application screensaver is at least partially independent of the management of any other particular application screensaver such that one application screensaver can be activated while other application screensavers are not.

Optionally, the stored screensaver activation condition for each of the at least one application program is a period of inactivity with the application program. Another option is that the screensaver deactivation condition for each of the at least one application programs is no longer detecting the occurrence or existence of the screensaver activation condition. Alternatively, the screensaver deactivation condition could be the entry of a specified password. The passwords for each application program may be the same or different.

The particular embodiment will preferably include the step of storing global desktop screensaver properties for the desktop of the computer system. Most preferably, the global desktop screensaver properties include a screensaver activation condition and a screensaver deactivation condition. For example, a global desktop screensaver process or image may be activated to overlay at least the client area of all running application windows in response to detecting the occurrence or existence of the screensaver activation condition for the global desktop screensaver. The global desktop screensaver process may be deactivated in response to no longer detecting the occurrence or existence of the screensaver activation condition for the global desktop screensaver. Optionally, the method may further include deactivating the at least one screensaver processes for the at least one application program in response to detecting the occurrence or existence of the screensaver deactivation condition for the global desktop screensaver. In a similar option, the method may include deactivating the at least one screensaver process in response to detecting the occurrence of the screensaver activation condition for the global desktop screensaver. Furthermore, the screensaver activation condition for the global desktop screensaver may be a period of inactivity with any application program. The screensaver deactivation condition for the global desktop screensaver may be the entry of a specified password.

In particular embodiments of the present invention, the screensaver program interacts or communicates with an application program interface (API), with a plug in or by other methods as would be appreciated by those having ordinary skill in the art. For example, an API is a set of routines, protocols and/or tools associated with a known operating system and/or application program. The API provides an interface with the operating system and/or application program for which it is associated. Therefore, an appropriate API may be selected that identifies the size and location of various application windows. The specific API may then be utilized to manage screensaver settings for individual user programs.

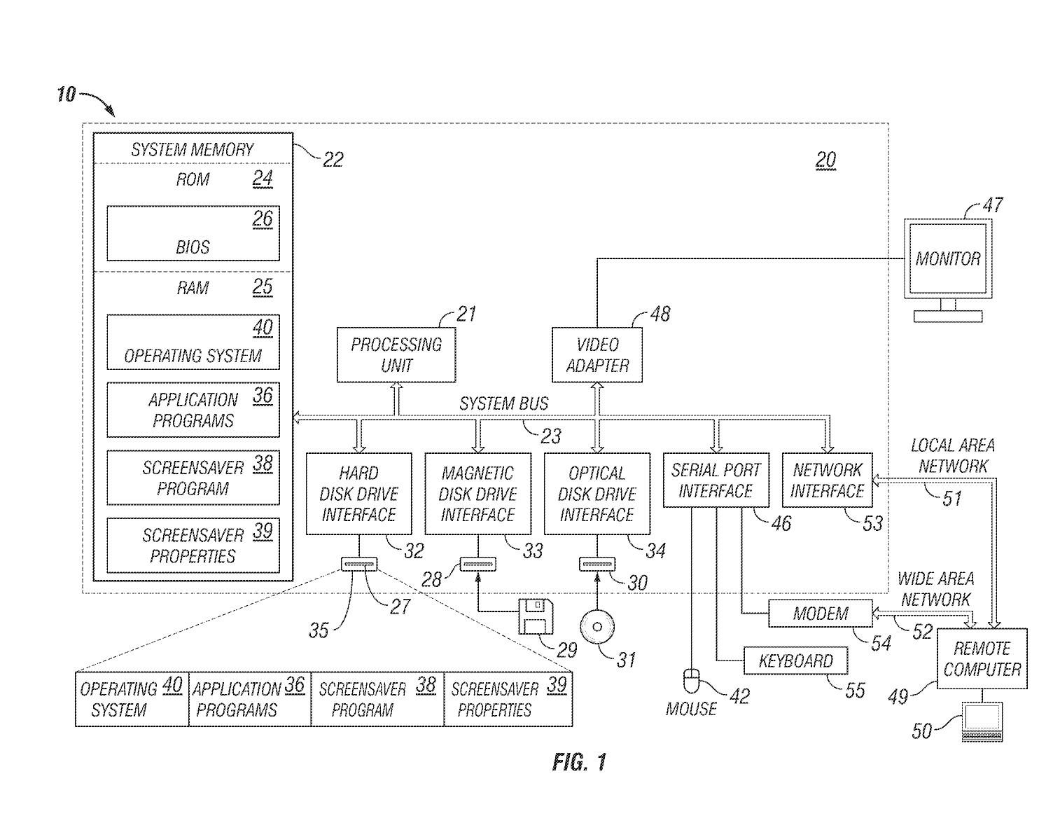

FIG. 1 is a schematic diagram of a system that is suitable for managing screensavers for individual programs. The system 10 includes a general-purpose computing device in the form of a conventional personal computer 20. Generally, a personal computer 20 includes a processing unit 21, a system memory 22, and a system bus 23 that couples various system components including the system memory 22 to processing unit 21. System bus 23 may be any of several types of bus structures including a memory bus or memory controller, a peripheral bus, and a local bus using any of a variety of bus architectures. The system memory includes a read only memory (ROM) 24 and random access memory (RAM) 25. A basic input/output system (BIOS) 26, containing the basic routines that help to transfer information between elements within personal computer 20, such as during start-up, is stored in ROM 24.

Personal computer 20 further includes a hard disk drive 35 for reading from and writing to a hard disk 27, a magnetic disk drive 28 for reading from or writing to a removable magnetic disk 29, and an optical disk drive 30 for reading from or writing to a removable optical disk 31 such as a CD-ROM or other optical media. Hard disk drive 35, magnetic disk drive 28, and optical disk drive 30 are connected to system bus 23 by a hard disk drive interface 32, a magnetic disk drive interface 33, and an optical disk drive interface 34, respectively. Although the exemplary environment described herein employs hard disk 27, removable magnetic disk 29, and removable optical disk 31, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for personal computer 20. For example, the operating system 40 and application programs 36 may be stored in the RAM 25 and/or hard disk 27 of the personal computer 20.

A user may enter commands and information into personal computer 20 through input devices, such as a keyboard 55 and a pointing device 42. Other input devices (not shown) may include a microphone, joystick, game pad, satellite dish, scanner, or the like. These and other input devices are often connected to processing unit 22 through a serial port interface 46 that is coupled to the system bus 23, but may be connected by other interfaces, such as a parallel port, game port, a universal serial bus (USB), or the like. A display device 47 may also be connected to system bus 23 via an interface, such as a video adapter 48. In addition to the monitor, personal computers typically include other peripheral output devices (not shown), such as speakers and printers.

The personal computer 20 may operate in a networked environment using logical connections to one or more remote computers 49. Remote computer 49 may be another personal computer, a server, a client, a router, a network PC, a peer device, a mainframe, a personal digital assistant, an Internet-connected mobile telephone or other common network node. While a remote computer 49 typically includes many or all of the elements described above relative to the personal computer 20, only a memory storage device 50 has been illustrated in the figure. The logical connections depicted in the figure include a local area network (LAN) 51 and a wide area network (WAN) 52. Such networking environments are commonplace in offices, enterprise-wide computer networks, intranets, and the Internet.

When used in a LAN networking environment, the personal computer 20 is often connected to the local area network 51 through a network interface or adapter 53. When used in a WAN networking environment, the personal computer 20 typically includes a modem 54 or other means for establishing high-speed communications over WAN 52, such as the Internet. Modem 54, which may be internal or external, is connected to system bus 23 via serial port interface 46. In a networked environment, program modules depicted relative to personal computer 20, or portions thereof, may be stored in the remote memory storage device 50. It will be appreciated that the network connections shown are exemplary and other means of establishing a communications link between the computers may be used.

A number of program modules may be stored on hard disk 27, magnetic disk 29, optical disk 31, ROM 24, or RAM 25, including an operating system 40, application programs 36, the screensaver program 38 and the screensaver properties 39 associated with one of the application programs. Program modules include routines, sub-routines, programs, objects, components, data structures, etc., which perform particular tasks or implement particular abstract data types. Aspects of the present invention may be implemented in the form of a screensaver program 38 and properties 39 associated with application programs 36, where the screensaver program will protect the privacy and security of displayed application program information in accordance with the screensaver properties. The screensaver program 38 generally comprises computer-executable instructions for, inter alia, identifying running application programs 36 and monitoring inactivity with these programs.

The described example shown in FIG. 1 does not imply architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

It should be recognized therefore, that embodiments of the present invention may take the form of an entirely hardware embodiment, an entirely software embodiment or an embodiment containing both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

While inventive embodiments of methods are demonstrated in the following flow charts of the figures that follow, it should be realized that the demonstrated methods are exemplary methods provided by the present invention and may be implemented using computer code and/or a suitable system.

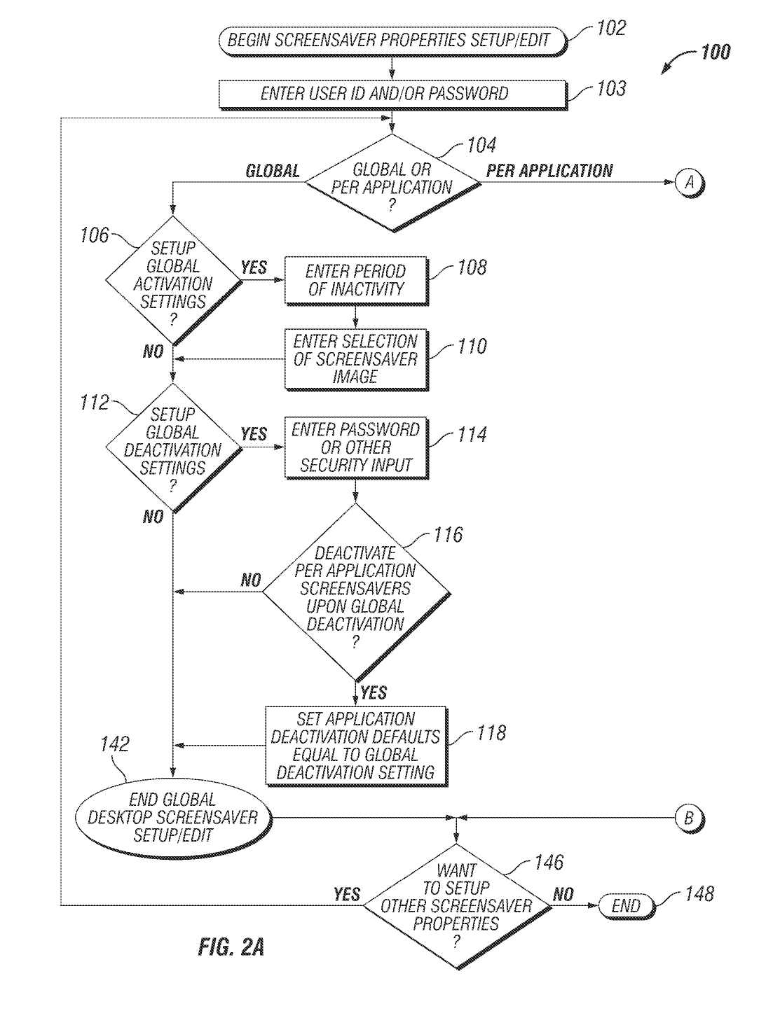

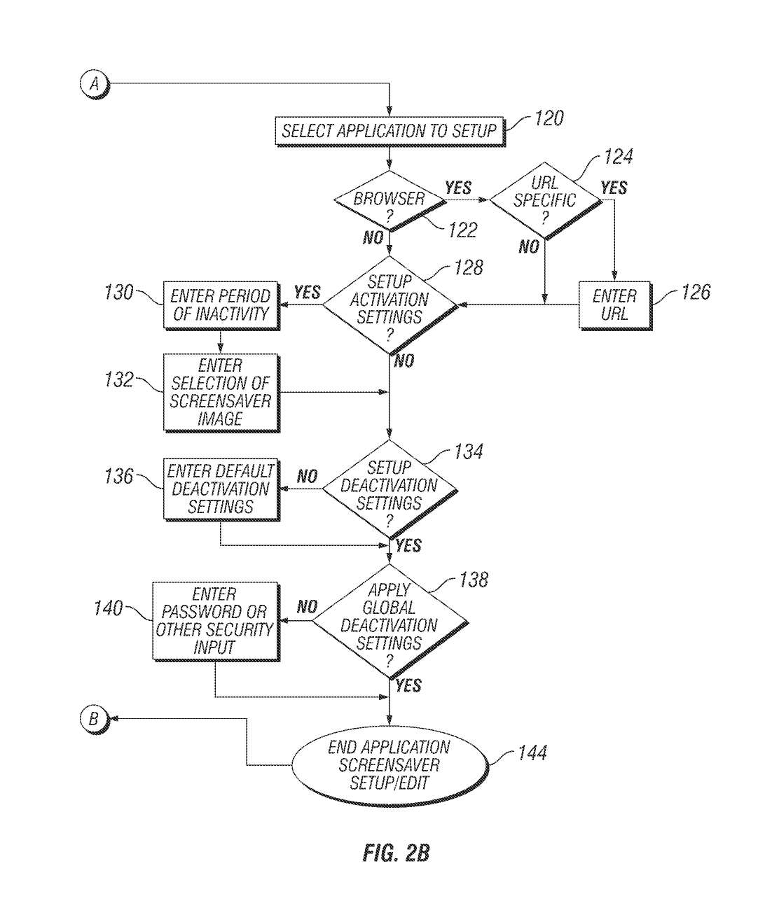

FIGS. 2A-B provide a flow chart of an exemplary method 100 for the setup or editing of screensaver properties for the global desktop and individual applications. In state 102, the screensaver properties setup or editing process begins. In state 103, a user or administrator can setup a user ID and/or password protection of the screensaver properties or, in subsequent sessions, enter the user ID and/or password that was setup in order to gain access that will allow editing of the screensaver properties. In state 104, the user is queried whether to setup or edit screensaver properties for the global desktop screensaver or a specific application screensaver. If the setup continues for the global desktop, then the process continues to state 106, where the user is queried whether to setup or edit the activation settings for the global desktop screensaver. In state 108, the user is prompted to enter, for example, a period of inactivity that will activate the application screensaver, and in state 110 the user is prompted to enter or select an application screensaver process or image.

In state 112, the user is asked whether to setup or edit the deactivation settings for the global desktop screensaver. To setup the deactivation settings, state 114 prompts the user to enter a password or other security input that will deactivate the global desktop screensaver, such as no longer detecting the global desktop screensaver activation condition. In accordance with an embodiment of the invention, state 116 asks the user whether application screensavers should be deactivated when the global desktop screensaver is deactivated. Selecting this option allows the user to regain access to all of the applications running on the computer following activation of the global desktop screensaver without having to meet a deactivation condition, such as the entry of a deactivation code or password, for each running application. If this option is positively selected, then in state 118 deactivation settings are applied to each application that is running to include deactivation via the global desktop screensaver.

Returning to state 104, if the user requests to setup or edit a screensaver for an individual application program, then the process continues to state 120 where the user selects the application for which the screensaver properties are to be setup. In accordance with an embodiment of the invention, the system determines, in state 122, whether the selected application is a web browser. If the selected application is a web browser, then state 124 gives the user the option to provide browser screensaver settings that are specific to the Uniform Resource Locator (URL) accessed with the browser (i.e., URL-specific settings). Accordingly, state 126 allows the user to identify the URL to be setup with its own screensaver properties. This embodiment may be useful, for example, to provide greater security when viewing account information on an online banking website than when accessing a publicly available news service.

In state 128, the user may select to setup or edit the screensaver activation settings for the selected application or browser/URL combination, then in state 130 the user may enter a period of inactivity as the activation setting and, in state 132, enter a selection of a screensaver process or image to utilize with the selected application. If the user elects not to setup activations settings in state 128 or finishes setup of activation settings in state 132, then the process continues to state 134 where the user is asked whether to setup or edit deactivation settings for the selected application. If the user does not setup deactivation settings, then default deactivation setting are established in state 136. In state 138, the user is given the option to apply the global screensaver deactivation settings to the selected application. If the user does not apply these settings, then state 140 prompts the user to enter a condition or input that will deactivate the application screensaver, such as no longer detecting the screensaver activation condition or successful entry of a password.

Following either the end of the global desktop screensaver setup in state 142 or the end of the application screensaver setup in state 144, the user is asked whether to setup other screensaver properties in state 146. To setup other screensaver properties, the process returns to state 104, as described above. If no more screensaver properties are to be setup, then the process ends at state 148.

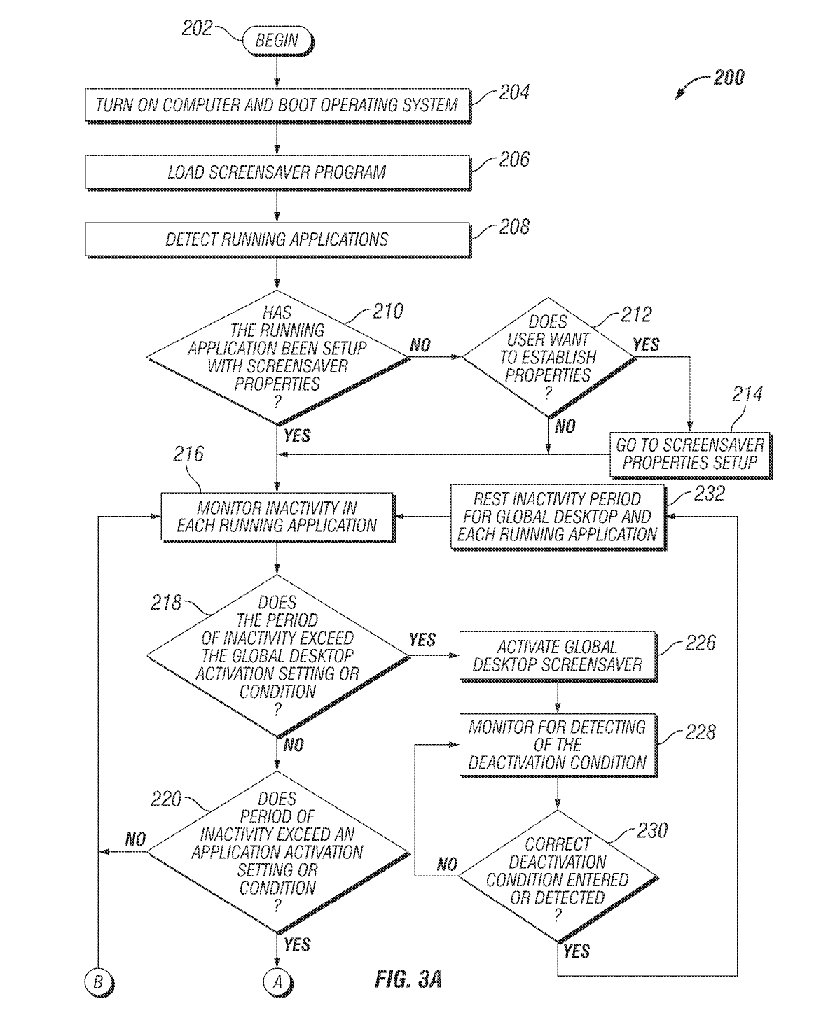

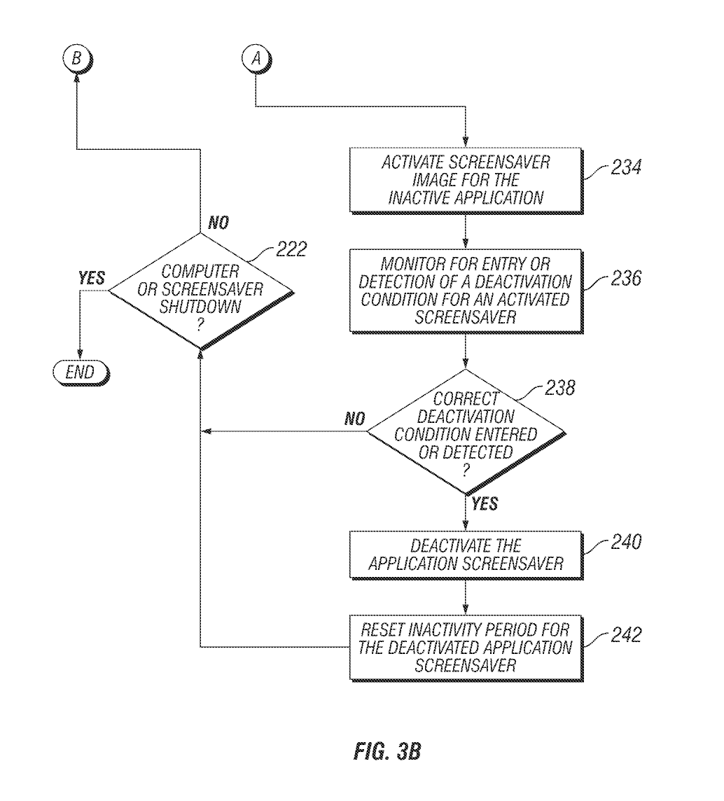

FIGS. 3A-B provide a flow chart of an exemplary method 200 of operating the screensaver program in accordance with the screensaver properties, such as those screensaver properties setup using method 100. The method begins in state 202, followed by startup of the computer and booting of the operating system in state 204. In state 206, the screensaver program is loaded into memory and, in state 208, the screensaver program detects applications that are running on the computer. Running programs may be identified by querying an application programming interface (API) for the operating system and/or querying the APIs of individual applications. If the program determines, in state 210, that there are no screensaver properties that are setup for a running application, then, in state 212, the user is asked whether to setup screensaver properties for this application. If screensaver properties are to be setup at this point, state 214 skips to the screensaver properties setup method 100 and returns to state 216 in response to completion of the setup.

In state 216, the method 200 monitors inactivity in each application program that is running on the computer. In the preferred embodiment, the method 200 may keep track of a period of inactivity for each application program separate and apart from the other application programs. Next, state 218 determines whether there is a period of computer inactivity that exceeds the global desktop screensaver activation setting. If the global desktop screensaver activation setting has not been reached, then state 220 determines whether there is a period of inactivity for any of the application programs that exceeds the screensaver activation setting for that application program. If none of the application program screensaver activation settings have been exceeded, then, unless the computer or screensaver is turned off in state 222 to end the process at state 224, the process loops back to state 216 to further monitor inactivity. So long as there is activity in the running application programs, the process will continue to loop through steps 216, 218 and 220.

However, if it is determined, in state 218, that the global desktop screensaver activation setting or condition has in fact been detected, such as a period of inactivity being exceeded, then the process branches to state 226 to activate the global desktop screensaver and then to state 228 to monitor for detecting a deactivation condition, such as no longer detecting the screensaver activation condition. State 230 loops the process back to state 228 until it is determined that the deactivation condition has been detected. The correct deactivation condition, such as entry of a correct password or no longer detecting a screensaver activation condition, leads the process to state 232 to reset the inactivity period for the global desktop and each running application program. Process 200 then returns to state 216 for further monitoring of inactivity.

Furthermore, if, in state 220, it is determined that a period of inactivity for any of the individual application programs exceeds the screensaver activation setting or condition for that application, then state 234 activates a screensaver process for the inactive application and state 236 monitors for entry or detection of a deactivation condition for an activated application program screensaver. If it is determined, in state 238, that an application program screensaver deactivation condition has not been detected, then the process returns to state 222. However, if a correct application screensaver deactivation condition has been detected, then state 238 leads to state 240 for deactivation of the application screensaver and to state 242 for resetting the inactivity period for the deactivated application program screensaver. Following state 242, the process returns to state 222.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A method of operating a screensaver on a computer system, comprising:
storing a screensaver activation condition for at least one application program selected from a plurality of application programs stored on the computer system; and
activating a screensaver process to overlay the client area of at least one running application window associated with the selected at least one application program in response to detecting the occurrence of the stored screensaver activation condition.

2. The method of claim 1, further comprising:
deactivating the screensaver process to expose the client area of the at least one running application window in response to no longer detecting the occurrence of the stored screensaver activation condition.

3. The method of claim 1, wherein the activated screensaver process overlays the client area of the at least one running application window and does not overlay the client area of any other running application window.

4. The method of claim 1, wherein the storing of a screensaver activation condition further comprises:
installing a screensaver at the time the at least one application program is installed;
identifying the screensaver activation condition at the time the at least one application program is installed; and
storing the identified screensaver activation condition in a program properties file associated with the at least one application program.

5. The method of claim 1, further comprising:
storing the identification of a screensaver process for the at least one application program in a program properties file associated with a plurality of screensavers.

6. The method of claim 1, wherein the screensaver activation condition for the application program comprises a period of inactivity of the at least one application program.

7. The method of claim 1, wherein the screensaver activation condition for the at least one application program further comprises:
disabling access to the client area of at least one running application window in response to detecting the occurrence of the stored screensaver activation condition; and
enabling access to the client area of at least one running application window in response to no longer detecting the occurrence of the stored screensaver activation condition.

8. The method of claim 1, further comprising
storing a global desktop screensaver activation condition for the desktop of the computer system; and
activating a global desktop screensaver process to overlay the client area of each running application window in response to detecting occurrence of the stored screensaver activation condition for the global desktop screensaver.

9. The method of claim 8, further comprising:
deactivating the global desktop screensaver process to expose the client area of each running application window in response to no longer detecting the occurrence of the stored screensaver activation condition for the global desktop screensaver.

10. The method of claim 9, further comprising:
deactivating the at least one application program screensaver process in response to no longer detecting the occurrence of the screensaver activation condition for the global desktop screensaver.

11. The method of claim 9, further comprising:
disabling access to the client area of each running application window in response to detecting the occurrence of the stored screensaver activation condition for the global desktop screensaver; and
enabling access to the client area of at least one running application window in response to no longer detecting the occurrence of the stored screensaver activation condition for the global desktop screensaver.

12. The method of claim 8, wherein the screensaver activation condition for the global desktop screensaver comprises a period of inactivity greater than or equal to the period of inactivity of the at least one application program.

13. The method of claim 9, wherein the screensaver activation condition for the global desktop screensaver is responsive to activating all screensaver process of the at least one running application window.

14. The method of claim 3, further comprising:
detecting the at least one running application window is being resized; and
resizing the overlayed client area of the at least one running application window in response to detecting the at least one running application window being resized.

15. The method of claim 6, wherein the period of inactivity is user defined for a plurality of application programs.

16. The method of claim 2, further comprising:
identifying a master screensaver deactivation condition; and
using the identified master screensaver deactivation condition to expose the client area of each running application window.

17. A computer program product comprising a computer useable medium having computer usable code for operating a screensaver on a computer system, the computer product comprising:
computer useable program code for storing a screensaver activation condition for at least one application program selected from a plurality of application programs stored on the computer system; and
computer useable program code for activating a screensaver process to overlay the client area of at least one running application window associated with the selected at least one application program in response to detecting the occurrence of the stored screensaver activation condition.

18. The computer program product of claim 17, further comprising:
computer useable program code for deactivating the screensaver process to expose the client area of the at least one running application window in response to no longer detecting the occurrence of the stored screensaver activation condition.

19. The computer program product of claim 17, further comprising:
computer useable program code for storing a global desktop screensaver activation condition for the desktop of the computer system; and
computer useable program code for activating a global desktop screensaver process to overlay the client area of each running application window in response to detecting the occurrence of the stored screensaver activation condition for the global desktop screensaver.

20. The computer program product of claim 19, further comprising:
computer useable program code for deactivating the global desktop screensaver process to expose the client area of each running application window in response to no longer detecting the occurrence of the stored screensaver activation condition for the global desktop screensaver.

21. A system for operating a screensaver on a computer system, the system comprising:
one or more processors coupled directly or indirectly to one or more memory devices and input/output devices, the input device adapted for loading an application program into at least one of the memory devices during installation of the application program on the computer system, wherein the application program includes a logical structure to provide instructions to the one or more processors for storing a screensaver activation condition for at least one application program selected from a plurality of application programs stored on the computer system; and activating a screensaver process to overlay the client area of at least one running application window associated with the selected at least one application program in response to detecting the occurrence of the stored screensaver activation condition.

22. The system of claim 21, wherein the application program further provides instructions to the one or more processors for deactivating the screensaver process to expose the client area of the at least one running application window in response to no longer detecting the occurrence of the stored screensaver activation condition.

23. The system of claim 21, wherein the application program further providing instructions to the one or more processors for storing a global desktop screensaver activation condition for the desktop of the computer system, and activating a global desktop screensaver process to overlay the client area of each running application windows in response to detecting occurrence of the stored screensaver activation condition for the global desktop screensaver, and deactivating the global desktop screensaver process in response to detecting occurrence of the global desktop screensaver deactivation condition.
